(19) United States
(12) Patent Application Publication
(10) Pub. No.: US 2007/0076671 A1
(43) Pub. Date: Apr. 5, 2007

(54) System and method for network infrastructure driven context setup to facilitate roaming

(75) Inventors: Nancy Winget, Mountain View, CA (US); Rajneesh Kumar, San Jose, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignee: Cisco Technology, Inc.

(21) Appl. No.: 11/240,002

(22) Filed: Sep. 30, 2005

(51) Int. Cl. H04Q 7/24

(52) U.S. Cl. 370/338

(57) ABSTRACT

A method and system for network infrastructure driven context setup to facilitate roaming for a client coupled to the network. The method includes generating an optimized list of the client's neighbors. The list is suitably generated either statically or dynamically based on any number of parameters managed by the network element to ensure an optimal set of AP candidates are provided. At least one access point is selected from the optimized list. A pre-allocation of resources is initiated with the at least one access point prior to the client roaming

### BACKGROUND OF THE INVENTION

The present invention relates generally to wireless networks and more specifically to a method and system that enables the network infrastructure to better manage the resources that are allocated for an active wireless (client) station.

Wireless network mobility and security have become a business critical issue. As a result of standards organizations such as the IETF (Internet Engineering Task Force) and IEEE (Institute of Electrical and Electronics Engineers) have been slowly addressing these requirements with the IEEE recently forming a new task group to address both. However, these standards are only addressing client (station) driven means to pre-allocate resources as a means to facilitate a roam. For instance, an IEEE solution uses the notion of enabling clients to better learn its neighbor topology through the use of a neighbor report.

As network topologies can be more complex, many network elements such as AAA servers, call managers, mobile IP agents and other authorization agents will also be involved in the handoff of a client when the client roams. The client is usually unaware of these other network elements and is thus unable to adequately perform the reallocation reservation and reauthorization of these resources.

Because clients are unaware of the activities of other clients, another potential problem with client initiated roaming is that many clients may simultaneously attempt to pre-allocate the same resources. The result is a “flooding” of these resources, which can starve resources of network elements such as a domain controller/WDS (Wireless Domain Server), call manager and AAA (Authentication, Authorization and Accounting) server.

### BRIEF SUMMARY OF THE INVENTION

In accordance with an aspect of the present invention, the present invention provides for an infrastructure driven context setup to facilitate roaming. The process includes a reservation or pre-allocation of resources. A network element, such as a controller or wireless domain server (WDS) managing the wireless client and access points (APs) generates an optimized list of the client's neighbors. The client's neighbor list can be generated by the controller in any number of ways, either statically or dynamically, based on any number of parameters managed by the network element to ensure an optimal set of AP (access point) candidates are provided. For example, the list can be generated by communicating with a centralized load balancer to determine what APs the client is most likely to roam to, or by determining the head room or admission capacity of neighboring access points. The network element then selects the AP (or APs) to initiate a pre-allocation of resources, such as security contexts (e.g. 802.11 security contexts such as keys and their lifetime) or pre-authentication as well as quality of service (QoS) resources such as a traffic specification (Tspec). Optionally, the network element can contact other network elements, for example a call manager, as needed to initiate the transfer from the old AP to the new AP. The network element can be configured to only accept roams (associations) from the client to only the AP (or APs) that the client has been pre-allocated.

In accordance with an aspect of the present invention, there is disclosed herein an network infrastructure driven context setup to facilitate roaming for a client coupled to the network. An optimized list of neighbors of the client is generated. At least one access point is selected from the optimized list. A pre-allocation of resources is initiated with the at least one access point.

In accordance with an aspect of the present invention, there is disclosed herein an infrastructure node that is communicatively coupled to a network. The infrastructure node comprising logic for generating an optimized list of neighbors for a client associated with the network. The infrastructure node further comprises logic for selecting at least one access point from the optimized list and initiating a pre-allocation of resources with the selected at least one access point.

In accordance with an aspect of the present invention, there is disclosed herein an infrastructure node that is coupled to a network. The infrastructure node comprising means for generating an optimized list for a client associated with the network of a client's neighbors for roaming. The infrastructure node further comprises means for selecting at least one access point from the optimized list and means for initiating a pre-allocation of resources with the at least one access point.

By enabling an infrastructure node, such as a controller/WDS to initiate the allocation of resources, roaming time for a client can be minimized. This allows better control and manageability of the network infrastructure by enabling the infrastructure node to drive the roam versus having the client initiate the roam. This can also minimize and better filter the potential flood of clients attempting to pre-allocate resources, which could starve the resources of different network elements such as controllers/WDS, call managers, AAA servers, etc. Network infrastructure pre-allocation can minimize the latencies incurred by the client and maximize battery life for the client.

Still other objects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention.

FIG. 1 is a block diagram of an exemplary wireless local area network (WLAN) configured in accordance with an aspect of the present invention.

FIG. 2 is a block diagram of an exemplary wireless local area network (WLAN) configured in accordance with an aspect of the present invention.

FIG. 3 is an example block diagram of a methodology in accordance with an aspect of the present invention.

FIG. 4 is block diagram of an example of an area serviced by a plurality of access points to illustrate an aspect of the present invention.

FIG. 5 is a block diagram of a high density network to illustrate an aspect of the present invention.

FIG. 6 is a block diagram that illustrates a computer system 500 upon which an embodiment of the invention may be implemented.

### DETAILED DESCRIPTION OF INVENTION

Throughout this description, the preferred embodiment and examples shown should be considered as exemplars, rather than limitations, of the present invention.

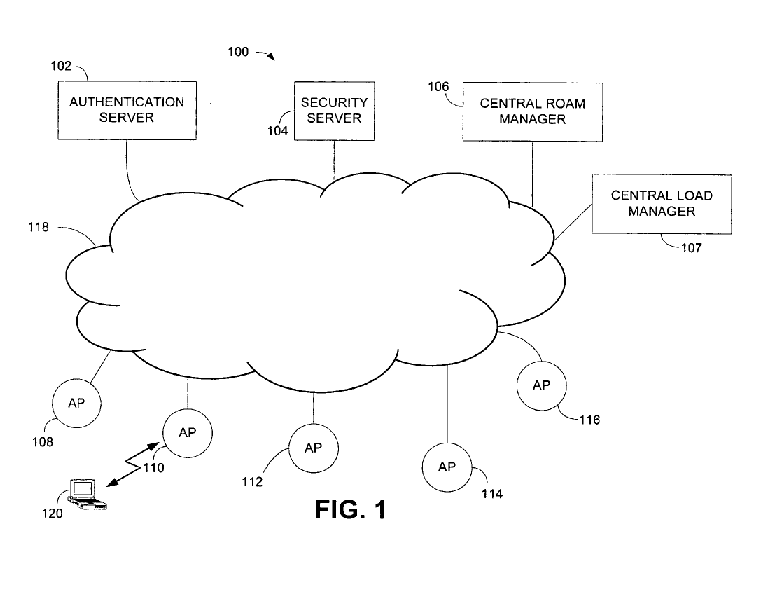

FIG. 1 is a block diagram of an exemplary wireless local area network (WLAN) 100 configured in accordance with an aspect of the present invention. Network 100 comprises an authentication (AAA) server 102, security server 104, central roam manger 106, access points 108, 110, 112, 114 and 116 coupled by backbone 118. A client 120 is associated with AP 110 and wirelessly communicates with AP 110 to access network 100.

AAA server 102 is used to authenticate client 120 with network 100. When client 120 attempts to associate with an access point 108, 110, 112, 114, 116, the access point accesses AAA server via backbone 118. AAA server 102 comprises logic for determining whether client 120 should be allowed to access network 100. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software.

Security server 104 performs the equivalent functions of an 802.11 security context server. Server 104 handles the security context including keys used to ultimately protect the data link. Security server 104 can determine whether a key that is sent by wireless client 120 is a valid and current key.

Central roam manager 106 is an infrastructure node configured to facilitate roaming within network 100. Central roam manager 106 comprises logic for generating an optimized list of a client's neighbors for a client associated with the network. Central roam manager 106 also comprises logic for selecting at least one access point from the optimized list, and logic for initiating a pre-allocation of resources with the at least one access point. For example, when client 120 associates with access point 110, central roam manager 106 generates an optimized list. The list may comprise the nearest neighbors of access point 110, e.g,. APs 108, 112. As another example, the list may comprise access points providing a specific type of service, e.g., APs servicing a multicast group). For example if APs 110 and 114 are servicing a multicast stream that wireless client 120 is receiving, then the optimized list would comprise AP 114 and not AP's 108 and 112 even though APs 108 and 112 are the closest APs to AP 110 because APs 108 and 112 do not service the multicast stream client 120 receives. Central roam manager 106 may also know what services client 120 needs (e.g. if it was in an active call) so that it may contact the call manager to pre-allocate or send an update of a potential roam as well.

Network 100 also has a central load manager 107 that functions as a central load balancer. Central load manager 107 comprises logic for determining the load on APs 108, 110, 112, 114, 116. The logic can determine the load by a variety of means. For example, central load manager 107 could poll APs 108, 110, 112, 114, 116 and request their current loads. Alternatively, central load manager 107 can obtain this information from AAA server 102 and/or security server 104 which also retain connection parameters for wireless client 120. As will be shown herein infra, for larger networks that have a controller or WDS, the central load manager 107 can obtain the data from the controller or WDS. Central load manager 107 may also monitor traffic (or contact a network ‘monitor’) to determine the load from specific AP's or group of AP's. As illustrated in FIG. 1 the central load manager 107 is a standalone component, but it is also contemplated, as will also be shown herein infra that central load manager 107 can be co-located with another infrastructure node, such as for example a WDS.

In accordance with an aspect of the present invention, central roam manager 106 can communicate with central load manager 107. Central roam manager 106 can generate the optimized list for roaming based on data received from central load manager 107. For example, as client 120 associates with AP 110, central roam manager 106 can ascertain the current load of APs 108, 110, 112, 114, 116 from central load manager 107. For example, if it is determined that AP 112 has a heavy load while APs 108 and 116 have light loads, then the optimized list generated by central roam manager 106 can contain APs 108 and 116 and not AP 112. As another example, the central roam manager 106 can communicate with central load manager 107 to determine the admission capacity of the client's neighbors, this would enable the optimized list to be dynamically generated as opposed to a static list that would only list the neighboring access points.

As another example of a dynamically generated optimized list, central roam manager 106 tracks where clients that have associated with AP 110 subsequently roam. For example, if central roam manager 106 determines that clients that associate with AP 110 roam to either AP 108 or AP 114, then the optimized list is generated containing AP 108 and AP 114.

After the optimized list is generated, logic in central roam manager 106 selects at least one AP from the optimized list to pre-allocate client 120. The logic in central roam manager 106 can select one AP, a group of APs or even all APs from the optimized list. For example, if 80% of clients associating with AP 110 subsequently associate with AP 112, then central roam manager 106 selects AP 112 for pre-allocation of resources of client 120. As another example, if most clients that associate with AP 110 associate with a group of APs (e.g., 40% of clients that associate with AP 110 roam to AP 112 and 35% roam to AP 116), then central roam manager 106 can select the group of APs (e.g., APs 112 and 116 ) to pre-allocate resources for client 120. Alternatively, as another example, once client 120 is associated with AP 110, central roam manager 106 initiates pre-allocation of resources of client 120 with APs 108, 112, 114 and 116.

In accordance with an aspect of the present invention, the logic for initiating a pre-allocation of resources in central roam manager 106 can be configured to contact a network element associated with the at least one access point. For example, central roam manager 106 can pre-authenticate client 120 with an AAA server (e.g., AAA server 102) associated with an AP (for example APs 108, 112, 114 and 116) that resources are being pre-allocated for client 120. In addition, central roam manager 106 can be configured to pre-allocate resources from a call manager and/or IP a mobile IP agent associated with a pre-allocated AP.

In accordance with an aspect of the present invention, central roam manager 106 can also control the roaming of wireless client 120. For example, central roam manager 106 pre-allocates resources for wireless client 120 with APs 108 and 112. When wireless client 120 roams, if wireless client 120 roams to APs 108 and 112 an association request from wireless client 120 will be granted. However, if wireless client 120 roams to another AP, e.g., either AP 114 or AP 116, then the association request can be denied. This feature can be particularly useful for load balancing.

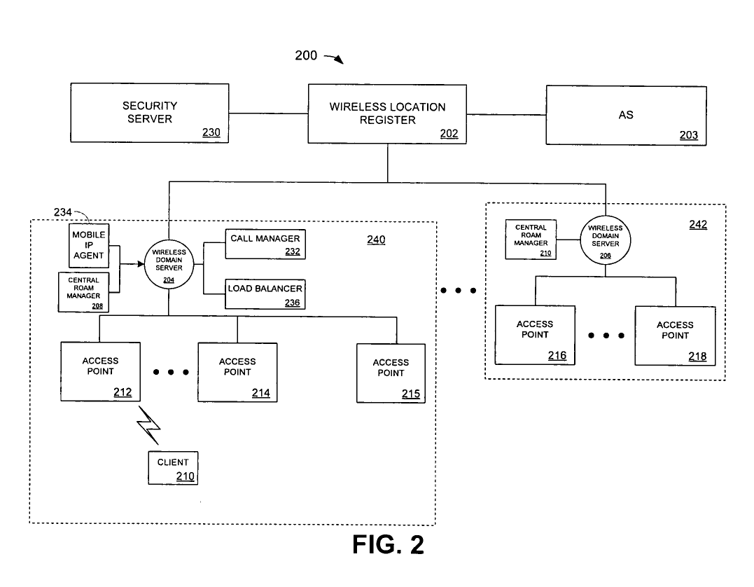

FIG. 2 is a block diagram of an exemplary hierarchical wireless local area network (WLAN) 200 configured in accordance with an aspect of the present invention. At the top of the hierarchical structure is a Wireless Location Register (WLR) 202. WLR 202 is the Root Infrastructure Node (IN) of topology tree of network 200. As used herein, an infrastructure node (IN) includes, but is not limited to a switch, router, Work-group Bridge (WGB), repeater AP, root AP, Wireless Domain Server (WDS) or a Wireless Location Register (WLR). Each infrastructure node comprises logic for performing the functions described herein. As illustrated, an AAA server 103 is coupled to WLR 202. WLR 202 can also serve as an infrastructure authenticator. All infrastructure nodes (e.g., WDS 204, 206 and APs 212, 214, 216, 218) are authenticated by WLR 202. Thus, if a client 220 is associated with a rogue node, WLR 202 can detect this and trigger a roam for client 220 to an authenticated infrastructure node.

Optionally, WLR 202 can employ a security server 230 for managing key distribution between infrastructure nodes 202, 204, 206, 212, 214, 216, 218. Furthermore, security server 230 manages key distribution between client 220 and the node the client is associated, AP 212 in this example. Security server 230 can also distribute keys to infrastructure nodes (e.g., AP 214) for pre-authentication. Security server 230 is suitably adaptable to be configured to manage key liveness. WDSs 204, 206 may share this information with AP's on their ‘branch’ to minimize the latency of client 220 having to go all the way up to WLR 202. Wireless domain servers 204, 206 are coupled to WLR 202. WDSs 204, 206 manage subnets 240, 242 of network 200. Each WDS 204, 206 maintains a registry and caches context information for nodes (e.g., APs 212, 214 and 215 for WDS 204 and APs 216 and 218 for WDS 206) in its wireless domain. Furthermore, WDS 204, 206 function as an 802.1X authenticator for nodes within its wireless domain. Central roam manager 208 is co-located with WDS 204 and provides for pre-allocation of resources for roaming within the domain covered by WDS 204 (i.e. central roam manager 208 is central to subnet 240). Central roam manager 210 is co-located with WDS 206 and provides for pre-allocation of resources for roaming within the domain covered by WDS 206 (i.e. central to subnet 240). Call manager 232 is also co-located with WDS 204. Although as illustrated central roam manager 208 and call manager 232 are co-located with WDS 204 and central roam manager 210 is co-located with WDS 206, this is merely for ease of illustration as these network elements can be located anywhere within the desired subnet.

APs 212, 214, 215 belong to subnet 240 and are coupled to WDS 204. Mobile IP agent 234 is co-located with WDS 204. Mobile IP agent 234 comprises logic for supporting mobile IP. AP 216, 242 belong to subnet 242 and are coupled to WDS 206.

In operation, when client 220 attaches to an AP, e.g., AP 212 as shown, the AP authenticates the client with authentication server 203. Once authentication is successful, client 220 is allowed to associate with AP 212. Security server 230 is typically the authenticator that does key management. Security server 230 propagates the necessary keying material to secure communications between AP 212 and client 220. Central roam manager 208 generates an optimized list of neighboring access points for client 210. Central roam manager 208 then selects at least one access point from the optimized list, for example AP 214. Central roam manager 208 then initiates a pre-allocation of resources with the at least one access point (e.g., AP 214).

To aid in selecting an AP, central roam manager 208 may communicate with a load balancer 236. Load balancer 236 comprises logic for determining the current load on APs 212, 214 in subnet 240. Thus by obtaining data from load balancer 236, central roam manager 208 may select a neighboring AP (e.g., AP 215) based on current admission capacity, as opposed to spatial orientation.

Alternatively, central roam manager 208 can select AP 214 based on observing where previous clients associated with AP 212 have roamed. For example, if the majority of clients associating with AP 212 roam to AP 214, then central roam manager 208 can select AP 214. As another alternative, the selection criteria can be statically programmed into central roam manager 208. For example, (as will be further explained with reference to FIG. 4 infra) if AP 212 is located at the entrance to a building and the next physical location a client would move to is a hallway served by AP 214, then central roam manager 208 can be programmed to select AP 214 when client 210 associates with AP 212.

After selecting an AP (e.g., AP 214) or a group of APs, central roam manager 208 initiates a pre-allocation of resources. In a preferred embodiment, the logic for pre-allocation in central roam manager 208 is further configured to pre-authenticate the client with at least one access point (e.g., AP 214). In addition, the logic for initiating a pre-allocation of resources may be further configured to pre-allocate at least one other network element associated with the at least one access point, for example call manager 232 and mobile IP agent 234 for AP 214.

In accordance with an aspect of the present invention, central roam manager 208 can control where client 210 roams after associating with AP 212. For example, if central roam manager 208 pre-allocates resources of AP 214 for client 210, then client 210 can be restricted to only associating with AP 214. If client 210 attempts to roam to a different AP, e.g., AP 215, the request from client 210 to associate with AP 215 can be denied.

Thus, as those skilled in the art can readily appreciate, an aspect of the present invention provides a means by which the network infrastructure can initiate pre-allocation of resources prior to a client's roam on behalf of the client and to further optimize and minimize the latencies on the client. Initiating of handoff of the wireless client could be triggered by a network element managing the wireless client for many reasons, including but not limited to load balancing, self healing (e.g., when an AP is shut down, stations currently serviced by the shut down AP are moved to an active AP), intrusion remediation (e.g., if a client is currently associated to a rogue AP, the client should be moved to an authorized AP).

By enabling a controller/WDS (or a central roam manager co-located or coupled to the WDS/controller) to initiate the allocation of resources, the roaming time for the client is further minimized. An aspect of the present invention provides better control and manageability of the network infrastructure by enabling the controller/WDS to drive the roam versus having the client initiating the roam.

An aspect of the present invention is that it can minimize and better filter the potential flood effects of clients attempting to pre-allocate resources, which could starve these resources. Network infrastructure elements, such as central roam managers, authentication servers, and WDSs are better able to monitor resources and steer clients to other resources when a resource is near capacity.

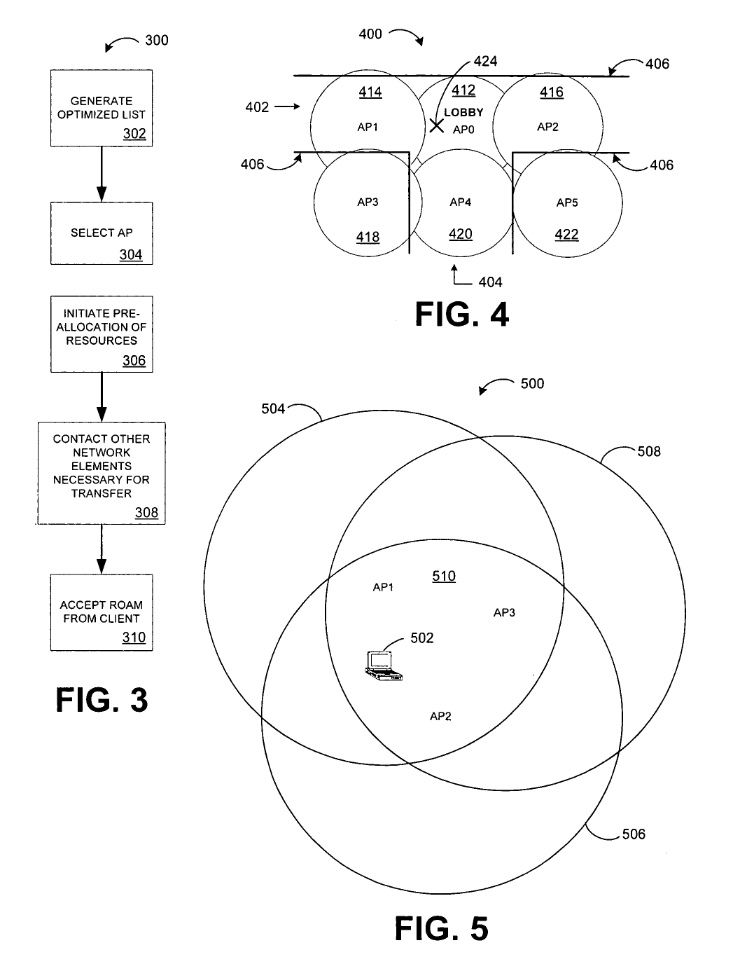

In view of the foregoing structural and functional features described above, a methodology in accordance with various aspects of the present invention will be better appreciated with reference to FIG. 3. While, for purposes of simplicity of explanation, the methodology of FIG. 3 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention. Embodiments of the present invention are suitably adapted to implement the methodology in hardware, software, or a combination thereof.

FIG. 3 is an example block diagram of a methodology 300 in accordance with an aspect of the present invention. Methodology 300 is for network infrastructure driven context setup to facilitate roaming for a client coupled to the network.

At 302, a network element, such as a controller or WDS, managing the wireless client and APs generates an optimized list of the client's neighbors. The client's neighbor list can be generated by any number of ways, either statically or dynamically based on any number of parameters managed by the network element to ensure an optimal set of AP candidates are provided. Some of the means for generating the neighbor list include communication with a centralized load balancer to ascertain which APs the station is likely to roam, knowledge of head room, or available admission capacity on applicable Access Class on potential APs. The list may then be used upon determination that the client needs to“roam.” The list can be generated based on knowledge of the physical area around the access point the client is associated, e.g., restrict roaming to only certain APs in physical proximity of the current AP, or can be generated based on dynamic observation of clients that have previously roamed from the currently associated AP.

At 304, at least one access point from the optimized list is selected by the network element. Because the network element knows the infrastructure topology, it can determine the most appropriate neighboring AP for the client. For a network with a centralized load balancer, the AP can be selected based on the available admission capacity or other criteria. For lists generated using other criteria, the best, or group of best APs matching the criteria can be selected. At 306, a pre-allocation of resources with the at least one access point is initiated. The pre-allocation of resources can include, but is not limited to, security contexts (e.g. 802.11 security contexts such as keys and their lifetimes, pre-authentication), as well as quality of service resources such as Traffic Specifications (TSpecs). At 308, if necessary, the network element contacts other network elements, such as a call manager or mobile IP agent, as required to initiate the transfer of the client from the currently associated AP to the selected neighboring AP.

At 310, the network element, e.g., controller or WDS, accepts roams from the client from an optimized and already pre-allocated (or “primed AP” or APs). If desired, the network element can reject roams from the client to APs that were not pre-allocated.

FIG. 4 is block diagram of an example of an area serviced by a network 400 comprising a plurality of access points to illustrate an aspect of the present invention. The example shows two hallways 402, 404 bounded by walls 406. While walls 406 may provide physical barriers, they may not be RF barriers and thus the client's ability to hear APs 418, 422 behind the walls can be equal to APs 412, 414, 416, 420 in hallways 402, 404. For example the walls may be small, though physically apparent. The lobby, which is at the intersection of hallways 402, 404 is served by AP0 which has a coverage area 412. AP1 and AP2 are adjacent to AP0 in hallway 402 and have coverage areas 414, 416 respectively. AP4 has a coverage area 420 that is adjacent to coverage area 412 of AP0. AP3 and AP5 have coverage areas 418, 422 respectively, but are on the other side of walls 406. As illustrated, if a wireless client is at location 424 in the lobby that is in coverage area 412 serviced by AP0, then because of the physical barriers imposed by walls 406, the wireless client can only roam to coverage areas 414, 416 or 420 services by AP1, AP2 and AP4 respectively. Therefore, a central roam manager can be configured to generate an optimized list containing AP1, AP2 and AP4. Coverage areas 418 and 422 can be excluded because it is not physically possible for the client to roam into these coverage areas, even though they are adjacent to coverage area 412. Conversely, if a client is in coverage area 418 serviced by AP3 or coverage area 422 serviced by AP5, the optimized list can exclude AP0, AP1, AP2 and AP4 because it is not physically possible for the client to roam into the coverage areas 412, 414, 416, 420 serviced by these APs. Thus, in accordance with an aspect of the present invention, knowledge of the physical topology of network 400 can be used to aid in the generation of the optimized list. In addition, knowledge of the client's past activities can also be used to aid in selecting APs for pre-allocation of resources. For example, if prior to arriving at location 424 the wireless client was in coverage area 414 serviced by AP1, then AP2 and AP4 can be selected as the most likely neighboring APs that the wireless client will roam.

FIG. 5 is a block diagram of a high density 500 network to illustrate an aspect of the present invention. Network 500 has an area 510 that is simultaneously served by AP1 with coverage area 504, AP2 with coverage area 506 and AP3 with coverage area 508. An aspect of the present invention is that as client 502 roams into area 510 of network 500, a network element (not shown, but could even be co-located with one of AP1, AP2 and AP3) within the network infrastructure of network 500 determines the best AP for client 502 to select for roaming. The criteria for selecting an AP for client 502 can be any parameter managed by the network element. For example, if client 502 belongs to a multicast group, client 502 can be pre-allocated with the AP that supports that multicast group. If more than one of the APs support the multicast group, then the AP with the best available admission capacity can be selected. In addition, if client 502 is currently associated with an AP in area 510 that shuts down, an aspect of the present invention is that the network infrastructure can self heal and direct client 502 to another AP that is still in operation. Another aspect of the present invention also allows for intrusion remediation. For example if it is determined that client 502 is currently associated with a rogue AP, the client can be pre-allocated and moved to AP1, AP2 or AP3.

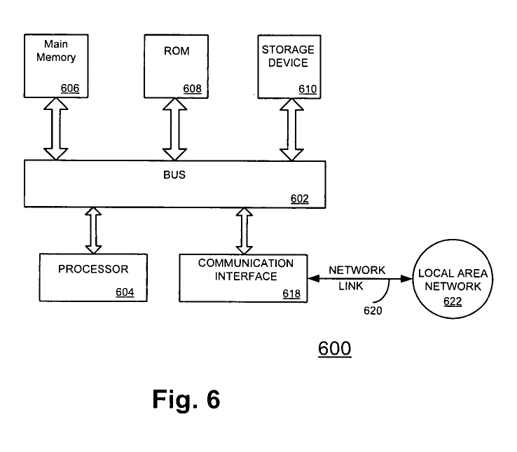

FIG. 6 is a block diagram that illustrates a computer system 600 upon which an embodiment of the invention may be implemented. Computer system 600 includes a bus 602 or other communication mechanism for communicating information and a processor 604 coupled with bus 602 for processing information. Computer system 600 also includes a main memory 606, such as random access memory (RAM) or other dynamic storage device coupled to bus 602 for storing information and instructions to be executed by processor 604. Main memory 606 also may be used for storing a temporary variable or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

The invention is related to the use of computer system 600 for network infrastructure driven context setup to facilitate roaming. According to one embodiment of the invention, network infrastructure driven context setup to facilitate roaming is provided by computer system 600 in response to processor 604 executing one or more sequences of one or more instructions contained in main memory 606. Such instructions may be read into main memory 606 from another computer-readable medium, such as storage device 610. Execution of the sequence of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to non-volatile media, volatile media, and transmission media. Non-volatile media include for example optical or magnetic disks, such as storage device 610. Volatile media include dynamic memory such as main memory 606. Transmission media include coaxial cables, copper wire and fiber optics, including the wires that comprise bus 602. Transmission media can also take the form of acoustic or light waves such as those generated during radio frequency (RF) and infrared (IR) data communications. Common forms of computer-readable media include for example floppy disk, a flexible disk, hard disk, magnetic cards, paper tape, any other physical medium with patterns of holes, a RAM, a PROM, an EPROM, a FLASHPROM, any other memory chip or cartridge, a carrier wave as described hereinafter, or any other medium from which a computer can read.

Computer system 600 also includes a communication interface 618 coupled to bus 602. Communication interface 618 provides a two-way data communication coupling to a network link 620 that is connected to a local network 622. This enables computer system 600 to communicate with other infrastructure nodes or network elements for implementing network infrastructure driven context setup to facilitate roaming.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

What is claimed is:

1. A method for network infrastructure driven context setup to facilitate roaming for a client coupled to the network, comprising:
associating a client with an access point;
generating an optimized list of neighboring access points of the access point;
selecting at least one access point from the optimized list; and
initiating a pre-allocation of resources with the at least one access point.

2. A method according to claim 1, wherein the generating the optimized list further comprises communicating with a centralized load balancer.

3. A method according to claim 2, wherein the communicating with a centralized load balancer further comprises determining the admission capacity of the client's neighbors.

4. A method according to claim 1, the generating the optimized list further comprises determining which of the neighboring access points are most likely access points for roaming.

5. A method according to claim 1, the pre-allocation comprises pre-authenticating the client with the at least one access point.

6. A method according to claim 1, the pre-allocation further comprises one of the group consisting of establishing security contexts and quality of service

7. A method according to claim 6, wherein the security contexts further comprises establishing security key values and lifetimes.

8. A method according to claim 6, wherein the quality of service specifications includes a traffic specification.

9. A method according to claim 1, the initiating further comprises pre-allocating at least one other network element associated with the at least one access point.

10. A method according to claim 9, wherein the at least one other network element is selected from the group consisting of an authentication server, a call manager, and a mobile IP agent.

11. A method according to claim 1, further comprising restricting the client to only allow roaming to the at least one access point.

12. An infrastructure node communicatively coupled to a network, comprising
logic for generating an optimized list of neighboring access points for an access point that a client is associated therewith;
logic for selecting at least one access point from the optimized list; and
logic for initiating a pre-allocation of resources with the at least one access point.

13. An infrastructure node according to claim 12, wherein the logic for generating the optimized list is configured to generate the list based on a communication with a centralized load balancer.

14. An infrastructure node according to claim 13, wherein logic for generating the optimized list is configured to communicate with the centralized load balancer to determine the admission capacity of the client's neighbors.

15. An infrastructure node according to claim 12, the logic for generating the optimized list is configured to dynamically determine which of the client's neighbors are most likely access points for roaming by observing where previous clients have roamed to after associating with the client's currently associated access point.

16. An infrastructure node according to claim 12, the logic for pre-allocation is further configured to pre-authenticate the client with the at least one access point.

17. An infrastructure node according to claim 12, the logic for initiating a pre-allocation of resources is further configured to pre-allocate at least one other network element associated with the at least one access point.

18. An infrastructure node according to claim 17, wherein the at least one other network element is selected from the group consisting of an authentication server, a call manager, and a mobile IP agent.

19. An infrastructure node according to claim 12, further comprising:
logic for determining whether the client has roamed to the at least one access point;
wherein the infrastructure node is configured to allow the client to associate with the at least one other access point responsive to determining the client has roamed to the at least one other access point; and
wherein the infrastructure node is configured to reject an association request from the client responsive to determining the client is attempting to associate with a node that is not the at least one other access point.

20. An infrastructure node coupled to a network, comprising:
means for generating an optimized list for a client associated with the network;
means for selecting at least one access point from the optimized list; and
means for initiating a pre-allocation of resources with the at least one access point.

21. An infrastructure node according to claim 20, the means for generating the optimized list further comprises means for determining the most likely access points for roaming from the optimized list.

22. An infrastructure node according to claim 20, further comprising means for pre-authenticating the client with the at least one access point.

23. An infrastructure node according to claim 20, further comprising means for restricting roaming of the client to the at least one access point.
